(19) United States
(12) Patent Application Publication
(10) Pub. No.: US 2025/0263002 A1
(43) Pub. Date: Aug. 21, 2025

(54) Holder for Mounting to a Cylinder Element

(71) Applicant: Scheidt & Bachmann GmbH, Mönchengladbach (DE)

(72) Inventor: Ibrahim Izler, Mönchengladbach (DE)

(21) Appl. No.: 19/044,117

(22) Filed: Feb. 3, 2025

(30) Foreign Application Priority Data
Feb. 15, 2024 (DE) 10 2024 104 216.8

(51) Int. Cl. B60N 3/02

(52) U.S. Cl. CPC B60N 3/026

(57) ABSTRACT

A holder for mounting to a cylinder element includes a base body and a carriage connectable to the base body. The base body includes a contact surface extending in the longitudinal direction for contacting, at least in sections, an outer side of the cylinder element. The base body includes at least two base body guide elements extending essentially in the longitudinal direction. The base body contact surface and the base body guide elements are tilted relative to one another by a base body angle of between 1° and 25°. A carriage contact surface extends in the longitudinal direction for contacting, at least in sections, an outer side of the cylinder element. The carriage includes at least two carriage guide elements extending substantially in the longitudinal direction being tilted relative to the carriage contact surface by a carriage angle of between 1° and 25°.

### CROSS-REFERENCE TO RELATED APPLICATIONS

This application claims the benefit of German patent application No. 10 2024 104 216.8 filed Feb. 15, 2024, the disclosure of which is incorporated herein by reference in its entirety.

### TECHNICAL FIELD

The invention relates to a holder for mounting to a cylinder element, in particular, for mounting a device to the cylinder element. Furthermore, the invention relates to a use, a method, a device set and a passenger transportation system.

### BACKGROUND ART

In passenger transport vehicles, but also in other applications, it is necessary to permanently mount a device to a cylinder element (e.g., running essentially vertically, i.e., in the direction of gravity). In particular, the cylinder element can be in the form of a tube. Passenger transport vehicles, such as buses and/or trains, are used in particular to transport users. The cylinder element can, for example, be a handrail in a passenger transport vehicle, and the device to be attached can be a validator for ticket media.

Passenger transport vehicles are used in (public) passenger transport systems. In order for a user to be able to use a passenger transport vehicle for its transportation in an authorized respectively permissible manner, the user regularly requires a valid respectively validated ticket medium. In particular, the prior art requires that, to be a valid ticket medium, the ticket medium must be validated by a validator before or when the transport journey starts.

For example, validating a ticket medium may comprise (wirelessly) reading a ticket code and/or a (unique) identifier from a ticket medium of the user. The identifier can be (uniquely) assigned to the user of the ticket medium and/or the ticket medium. Examples of ticket media include, but are not limited to, tokens, chip cards (respectively smart cards), credit cards, bank cards (or similar), cell phones, personal digital assistants (PDAs), tablet PCs, integrated circuit chips, electronic passports, electronic ID documents, and electronic rings.

A validator may comprise at least one electronic interface and a detecting module, respectively, with at least one electronic interface. The (contactless or contact-based) interface corresponds to the (contactless or contact-based) interface of the ticket medium. Non-exhaustive examples of contact-based ticket media interfaces are magnetic stripes and Europay-Mastercard-VISA (EMV) chips; examples of preferred contactless ticket media interfaces are ISO 14443 Near Field Communication (NFC) interfaces.

A detection process respectively reading process may also be referred to as a “tap”. In particular, a user can hold respectively tap the ticket medium on or in the interface of the validator to cause a detecting of the ticket code and/or the identifier. As already described, tapping can be done contactlessly, preferably by NFC (e.g., smart cards according to ISO 14443), by reading an optical code (e.g., barcode, QR code) that contains the electronic medium identifier from a mobile terminal, by reading data from a Bluetooth interface or in a contact-based manner by reading data from a magnetic stripe or from a contact-based chip from a bank card or credit card. In particular, a ticket medium can be validated by reading it in a corresponding manner so that it is considered to be a valid ticket medium (for example, in a conventional inspection by an inspector).

It shall be understood that other ticket media can also be used, such as conventional paper tickets.

In order to enable a ticket medium to be validated when a journey on the transportation system starts, validators, also known as ticket validators, are regularly arranged on a cylinder element, for example, in a passenger transportation vehicle.

In order to mount a validator to the cylinder element, a standard holder is used in the prior art. This standard holder is mounted to the cylinder element and carries respectively holds the validator. For this purpose, the holder can comprise at least one fastening element for mounting the validator to the holder.

In practice, the mounting of validators is significantly impeded by the fact that the cylinder elements in the various types of passenger transportation vehicles regularly have different diameters. In particular, there is a large number of different types of passenger transportation vehicles in the prior art, each of which having cylinder elements, in particular, in the form of tubes (respectively handrails in passenger transportation vehicles) with different diameters. Thus, the diameter of the cylinder elements in the (various) passenger transport vehicles can vary between 28 mm and 45 mm.

A standard holder of the prior art is formed in two parts and comprises a base body and a counter piece. The base body and the counter piece can be connected to each other by a plurality of screw connections in order to be mounted to the cylinder element. Both the base body and the counter piece each have a contact surface whose respective inner shape essentially corresponds to the outer shape of the cylinder element. In particular, when the base body and the counter piece are connected, the standard holder has a holder diameter that essentially corresponds to the diameter of the maximum possible cylinder element, i.e., in particular 45 mm.

In order to securely mount the standard holder to the cylinder element, one or more adapter sleeves are usually placed between the contact surfaces and the outer side of the cylinder element with a diameter of less than 45 mm based on the diameter of the cylinder element and the thicknesses of the available adapter sleeves. Then it is necessary that one fitter holds the base body and the counter piece as well as the at least one adapter sleeve in position while a further fitter establishes the plurality of screw connections (respectively tightens the corresponding screws) so that the holder together with the adapter sleeves is mounted to the cylinder element with sufficient security.

During the mounting process, the fitters are regularly faced with the additional complication that at least one cable, such as a data cable and/or a power cable respectively energy cable, must be routed from the cylinder element through one or more adapter sleeves and the base body, in particular, to the validator to be mounted.

Overall, the effort involved in mounting a validator or another device to a cylinder element in the prior art is very laborious.

Therefore, the object of the present invention is to provide a possibility to simplify the mounting of a device, in particular, a validator, to a cylinder element, and in particular to make it possible for just a single fitter to carry out the work.

### SUMMARY OF THE INVENTION

The object is solved according to a first aspect of the invention by a holder for mounting to a cylinder element, in particular, for mounting a device to the cylinder element. The holder comprises a base body. The holder comprises a carriage connectable to the base body. In the mounted state of the holder, a longitudinal direction of the base body and of the carriage extends essentially parallel to the longitudinal axis of the cylinder element. The base body comprises a base body contact surface extending in the longitudinal direction (of the base body) for contacting, at least in sections, an outer side of the cylinder element. The base body comprises at least two base body guide elements extending essentially in the longitudinal direction (of the base body). The base body contact surface and the base body guide elements are tilted relative to one another by a base body angle of between 1° and 25°. The carriage comprises a carriage contact surface extending in the longitudinal direction (of the carriage) for contacting, at least in sections, with the outer side of the cylinder element. The carriage comprises at least two carriage guide elements extending essentially in the longitudinal direction (of the carriage). The carriage contact surface and the carriage guide elements are tilted relative to one another by an angle of between 1° and 25°. The base body guide elements correspond to the carriage guide elements in such a way that a first moving (in the longitudinal direction) of the carriage relative to the base body with the corresponding base body guide elements and carriage guide elements in engagement with each other a reducing of the (effective) diameter of the holder is caused so that a (self-locking) seizing of the holder with the cylinder element arranged between the base body and the carriage is caused. According to a preferred embodiment of the holder according to the invention, the base body guide elements can correspond to the carriage guide elements in such a way that by a second moving of the carriage relative to the base body, which is opposed to the first moving, with the corresponding base body guide elements and carriage guide elements in engagement with one another, an increasing of the effective diameter of the holder is caused so that the seizing of the holder with the cylinder element arranged between the base body and the carriage is released.

By providing, in contrast to the prior art, a holder, in particular, a two-part holder, comprising a base body with base body guide elements and a base body contact surface and a carriage with carriage guide elements and a carriage contact surface, in which, due to a respective angular arrangement of respective guide elements to respective contact surfaces, a relatively moving of the carriage to the base body can cause the holder to seize with the cylinder element, thus creating a possibility by which the mounting of a device, in particular, a validator, to a cylinder element is simplified and, in particular, is performable by just a single fitter.

In particular, the carriage can be displaced relative to the base body with a cylinder element arranged between the carriage and the base body (with corresponding guide elements in engagement) in such a way that an effective holder diameter, which is formed by the opposing carriage and base body contact surfaces, is continuously reduced, in particular, until the effective holder diameter corresponds to the outer cylinder element diameter. In this state, also referred to as the seized state, the holder is held seized to the cylinder element due to the static friction acting in the contacting areas.

According to the invention, adapter sleeves or the like can be dispensed with. Furthermore, the holder can be installed by a single fitter. The base body can be brought with one hand and the carriage with the other hand into the seized state. Optionally, a locking can be performed in the seized state, as will be described later. In particular, a final locking respectively fixing can be carried out by a single fitter since the holder is already seized to the cylinder element and held respectively mounted (and no further fitter is needed to hold the holder in this position).

According to the invention, a holder is provided for mounting to a cylinder element. In particular, the cylinder element has a circular cross-section. For example, the cylinder element may be a pipe respectively a rod. In a passenger transportation vehicle (e.g., bus, train, watercraft, etc.), a cylinder element may extend and run, respectively, essentially in a vertical direction, i.e., in the direction of gravity. It shall be understood that the cylinder element may also be located in another location, such as in a station area and/or a stop area.

The holder serves as a mounting apparatus for (permanently, but in particular reversibly) mounting a device to the cylinder element. In other words, the holder can be mounted to the cylinder element and (in turn) the device can be mounted to the holder. For this purpose, the holder can have at least one fastening means to which the device can be mounted.

According to an embodiment, the holder is configured to carry a device weighing up to 10 kg. In other words, the payload of the holder can be up to 10 kg, for example, approx. 3 kg. The holder, in particular, the base body, can comprise at least one fastening element for (permanently, but in particular reversibly) fastening the device to be held respectively carried.

In particular, the device can be a validator (of a ticket system) of a passenger transportation system. A validator respectively a ticket validator (e.g., with a weight of about 3 kg) is configured to validate ticket media. It shall be understood that other devices can also be mounted to a cylinder element by means of the holder.

A validator can comprise at least one electronic interface and a detecting module, respectively, with at least one electronic interface (for validating a ticket medium). The at least one (contactless or contact-based) interface corresponds to the (contactless or contact-based) interface of the ticket medium to be validated. Non-exhaustive examples of contact-based ticket medium interfaces are magnetic strips and Europay-Mastercard-VISA chips (EMV chips); examples of preferred contactless ticket medium interfaces are Nearfield Communication interfaces (NFC interfaces) in accordance with ISO 14443.

As described, a detecting process can be carried out in order to validate a ticket medium. A detection process respectively read process can also be referred to as a “tap”. In particular, a user can hold respectively tap the ticket medium on or in the interface of a validator to detect a ticket code and/or an identifier stored in the ticket medium, which can be uniquely assigned to the user of the ticket medium and/or the ticket medium.

As already described, the tapping can be done contactless, preferably by NFC (e.g., smart cards according to ISO 14443), by reading an optical code (e.g., barcode, QR code) that contains the medium identifier and/or the ticket code from a mobile device, by reading data (medium identifier and/or ticket code) from a Bluetooth interface or in a contact-based manner by reading data (medium identifier and/or ticket code) from a magnetic stripe or from a contact-based chip of a bank card or credit card. In particular, a ticket medium can be validated by a corresponding reading so that it is considered to be a valid ticket medium (for example, during a (conventional) inspection process carried out during the transport journey).

It shall be understood that other ticket media (and corresponding interfaces on the validator) can also be used, such as conventional paper tickets.

The holder according to the invention is, in particular, formed in two parts. Preferably, the holder is formed by exactly two parts, namely a base body and a carriage (not included are small parts such as screws, nuts, washers, etc.). In particular, the holder does not include any adapter sleeves or the like.

The base body and the carriage are, in particular, designed such that they are connectable respectively couplable to one another. As will be described later, the base body can comprise base body connecting elements in the form of at least two base body guide elements and the carriage can comprise carriage body connecting elements in the form of at least two carriage guide elements, in particular, to connect the base body to the carriage.

The carriage can preferably be made of metal, particularly preferably of aluminum. In particular, the carriage and base body can be made of the same material. For example, a carriage and/or a base body can be made of cast material or a milled solid material. It shall be understood that in other variants of the invention, a different material can also be used alternatively or additionally, such as (high strength) plastic.

According to the invention, the base body comprises a base body contact surface. The base body contact surface is configured to contact, at least in sections, an outer side of the cylinder element. This means, in particular, that in an installed state respectively mounted state of the holder, the base body contact surface makes direct contact, at least in sections, with the outer side of the cylinder element. Direct contact means, in particular, that no adapter sleeve or the like is arranged between the base body contact surface and the outer side of the cylinder element.

The base body contact surface extends, in particular, in a longitudinal direction of the base body. In the mounted state of the holder, the longitudinal direction corresponds, in particular, to the direction of the longitudinal axis of the cylinder element (e.g., a vertical direction).

As already described, the base body comprises at least two base body guide elements. In particular, a base body guide element is a guide element extending in the aforementioned longitudinal direction. According to a preferred embodiment, a base body guide element can be a base body guide rail.

The at least two base body guide elements can be formed identically. Furthermore, the base body guide elements can preferably run parallel to one another. In particular, two parallel (and identically formed) base body guide rails can be provided as base body guide elements.

According to the invention, the base body guide elements run at an angle to the base body contact surface. This means, in particular, that the base body contact surface and the (at least two) base body guide elements running parallel to one another are tilted in relation to one another by a base body angle of between 1° and 25°.

According to the invention, the carriage has a carriage contact surface. The carriage contact surface is configured to contact, at least in sections, an outer side of the cylinder element. This means, in particular, that, in an installed state respectively mounted state of the holder, the carriage contact surface makes direct contact, at least in sections, with the outer side of the cylinder element. Direct contact means, in particular, that no adapter sleeve or the like is arranged between the carriage contact surface and the outer side of the cylinder element.

The carriage contact surface extends, in particular, in a longitudinal direction of the carriage, which in the mounted state may correspond to the longitudinal direction of the base body. In the mounted state, the longitudinal direction of the holder corresponds, in particular, to the longitudinal axis direction of the cylinder element (e.g., a vertical direction).

As already described, the carriage comprises at least two carriage guide elements. In particular, a carriage guide element is a guide element extending in the aforementioned longitudinal direction. According to a preferred embodiment, a carriage guide element can be a carriage guide rail.

The at least two carriage guide elements can be formed identically. Furthermore, the carriage elements can preferably run parallel to one another. In particular, two parallel (and identically formed) carriage guide rails can be provided as carriage guide elements.

According to the invention, the carriage elements extend at an angle to the carriage contact surface. This means, in particular, that the carriage contact surface and the (at least two) carriage guide elements extending parallel to one another are tilted relative to one another by a carriage angle of between 1° and 25°.

As already described, the carriage guide elements and the base body guide elements serve to connect the carriage and the base body to one another. In particular, the carriage guide elements correspond to the base body guide elements. This means, in particular, that the carriage guide elements and the base body guide elements are matched to one another in shape and position in such a way that they engage with one another to connect the carriage and the base body. In particular, the base body guide elements can form a first guide rail system that is matched to a second guide rail system formed by the base body guide elements. In particular, each base body guide rail can comprise a rail profile that corresponds to the rail profile of a corresponding carriage guide rail in such a way that the base body guide rail and the carriage guide rail can engage with each other and guide each other (in the engaged state).

In other words, the base body guide elements correspond to the carriage guide elements in such a way that a relative movement (in the longitudinal direction) of the carriage to the base body, when the corresponding base body guide elements and carriage guide elements are in engagement with each other, causes the holder to be seized to the cylinder element. This means, in particular, that the carriage can be moved and pushed, respectively, from an unseized position into a seized position (and in particular in the opposite direction). When seized, the holder is, in particular, in a (self-locking) seized state.

In particular, a fitter can use one hand to place the base body with the base body contact surface against the outer side of the cylinder element. Then, with the other hand, the carriage can be held and the corresponding base body guide elements and carriage guide elements can be engaged with each other. By moving the carriage and due to the angular arrangement between the respective guide elements and the respective contact surfaces, the effective holder diameter, which is formed by the opposing carriage contact surfaces and base body contact surfaces, can be continuously reduced, in particular, until the (effective) holder diameter essentially corresponds to the outer cylinder element diameter. In this state, also referred to as the seized state, the holder is held seized on the cylinder element due to the static friction acting in the contacting areas.

According to an embodiment of the holder according to the invention, the base body angle and the carriage angle can be essentially the same. In particular, it can be achieved by essentially identical angles that the contact area formed directly between the holder and the cylinder element in the seized state is maximized. The static friction can be further increased.

According to a preferred embodiment of the holder according to the invention, the base body angle can be between 9° and 12°, preferably essentially 10°. Alternatively or preferably in addition, the carriage angle can be between 9° and 12°, preferably essentially 10°. It has been recognized that a particularly good static friction can be achieved between the holder and the cylinder element. In particular, it has been recognized that with base body and carriage angles between 9° and 12°, self-locking of the base body and the carriage and the cylinder element is achieved in the seized state. This means that the arrangement, once “seized” together, is mounted by the seizing friction in such a way that it does not come loose on its own, in particular, unless vibration or other mechanical (manual) action changes the position of the carriage. This means, in particular, that a single fitter can initially establish the seized state, then let go of the pre-assembled holder and lock respectively fix it with a release lock.

According to a further embodiment of the holder according to the invention, the base body contact surface can be essentially parallel to the carriage contact surface when the base body guide elements and the carriage guide elements are engaged with each other.

According to a further preferred embodiment of the holder according to the invention, the base body and the carriage can be matched respectively designed to one another such that the holder diameter can be adjusted by a relatively moving the carriage to the base body with the corresponding base body guide elements and carriage guide elements engaged to at least between 28 mm and 45 mm. In particular, by the relatively displacing the holder diameter can be reduced (in principle) from a maximum of at least 45 mm to a minimum of at least 28 mm. This allows a mounting of the holder to cylinder elements with diameters between 28 mm and 45 mm, in particular, without the need for adapter sleeves or the like.

According to a further preferred embodiment of the holder according to the invention, the base body can comprise a base body cable opening corresponding to a cable opening of the cylinder element. The base body cable opening can be configured to pass through at least one cable led out of the cable opening of the cylinder element through the holder, in particular, to the device to be carried, such as the validator.

The device to be carried can comprise at least one electrical consumer and/or a data interface, such as the at least one electronic interface described. In particular, the at least one cable can be a data cable and/or a power cable. For example, the power cable can be connected to an energy source (e.g., a battery of the passenger transport vehicle). The data cable can be connected, for example, to a computing device (e.g., of the passenger transport vehicle) and/or a communication device (e.g., of the passenger transport vehicle).

Preferably, the at least one cable can be routed inside the (hollow cylindrical) cylinder element. The at least one cable can be routed out of the cylinder element through a cable opening in the cylinder element in order to be connected to the device to be carried. In order to be able to route the at least one cable out of the cylinder element and through the holder to the device, it is proposed, in accordance with this embodiment, to provide a base body cable opening in the base body. The base body cable opening can correspond essentially to the cable opening of the cylinder element, that is, it can be matched to the cable opening, in particular, with regard to size and/or shape. Preferably, the base body cable opening can be arranged in the base body contact surface.

The holder can be held seized to the cylinder element in such a way that the base body cable opening is essentially opposite the cable opening of the cylinder element. The at least one cable can exit the cylinder element through the cable opening and enter the holder directly through the base body cable opening. One or more cables can be routed securely from the cylinder element through the holder to the device.

According to a particularly preferred embodiment of the holder according to the invention, the base body can comprise at least one anti-twist element that protrudes from the base body contact surface. The anti-twist element can protrude into respectively engage in an opening of the cylinder element in a seized state of the holder. The opening can be, in particular, the cable opening.

In particular, the at least one anti-twist element can be arranged in an edge region of the base body cable opening. Preferably, the at least one anti-twist element can form a sub-region of the edge region of the base body cable opening. Preferably, the at least one anti-twist element can be a partially collar-shaped anti-twist element, which in particular forms a sub-region of the edge region of the base body cable opening. In that the at least one anti-twist element projects into the cable opening in the seized state of the holder, in particular, an anti-twist protection of the holder is provided. In particular, a twist of the device in the circumferential direction of the cylinder element (e.g., due to attempted vandalism) is blocked (in a secure manner), in particular, by the anti-twist element stooping at the edge of the cable opening of the cylinder element.

It is particularly preferred that at least two anti-twist elements can be arranged in an edge region. The at least two anti-twist elements can be arranged at least partially on opposite edge regions of the base body cable opening. Preferably, the external diameter of the at least two opposite anti-twist elements can essentially correspond to the internal diameter of the cable opening of the cylinder element (e.g., with a predetermined tolerance).

In particular, the base body can be (optimally) positioned on the cylinder element by means of the anti-twist elements by inserting the at least two anti-twist elements into the cable opening. In other words, in this case the anti-twist elements can additionally be used as a positioning aid. In addition, a particularly effective anti-twist protection is provided.

According to a further embodiment of the holder according to the invention, an inner shape of the carriage contact surface can essentially correspond to an outer shape of the cylinder element and/or an inner shape of the base body contact surface can essentially correspond to an outer shape of the cylinder element.

Preferably, the inner shape of the carriage contact surface can have an essentially quadrant-circular to semi-circular inner contour. It shall be understood that the progression of the inner contour can be at least partially angular and straight (to form the substantially quadrant-shaped to semicircular inner contour), for example, trapezoidal with an open long base. Seizing of the holder can be further simplified.

Preferably, the inner shape of the base body contact surface can have an essentially quadrant-shaped to semi-circular inner contour. It shall be understood that the contour can be angular and straight (to form the substantially quadrant-shaped to semi-circular inner contour), for example, trapezoidal with an open long base side. Seizing of the holder can be further simplified.

In addition, according to a preferred embodiment of the holder according to the invention, the carriage contact surface may comprise at least one longitudinally extending corrugated strip (also referred to as a corrugated strip) for contacting the outer side of the cylinder element. Preferably, at least two corrugated strips may be arranged.

Alternatively or in addition, the base body contact surface can comprise at least one corrugated strip (also referred to as a corrugated strip) extending in the longitudinal direction for contacting the outer side of the cylinder element. Preferably, at least two corrugated strips can be arranged.

A corrugated strip comprises, in particular, a plurality of longitudinally alternating ridges and grooves. The vertical distance between a groove and a ridge respectively the height of a ridge can be between 0.1 mm and 5 mm, preferably between 0.1 mm and 2 mm. The distance between two neighboring ridges can be between 0.1 mm and 5 mm, preferably between 0.1 mm and 2 mm. The width of a corrugated strip can be between 0.2 mm and 5 mm, preferably between 0.5 mm and 2 mm. The length of a corrugated strip can preferably essentially correspond to the length of the carriage contact surface and the base body contact surface, respectively.

The surface area, in which the carriage contact surface and the base body contact surface of the holder and the cylinder element (in the seized state) actually contact respectively directly touch each other, can, in particular, essentially be determined by the at least one (preferably two) corrugated strip(s) (respectively the aforementioned ridges) of the carriage contact surface and by the at least one (preferably two) corrugated strip(s) (respectively the aforementioned ridges) of the base body contact surface. When the carriage moves relative to the base body to cause the seizing of the cylinder element, the ridges respectively teeth of a corrugated strip “bite” into the outer side respectively outer surface of the cylinder element. This ensures, in particular, a micro-toothing between the respective corrugated strip and the cylinder element and thus, in particular, a particularly effective static friction. As will be described later, this effect can be further enhanced if, for example, an additional locking respectively fixing is provided, for example, by means of at least one screw connection.

The effect of a micro-toothing can also be increased if the cylinder element (at least in the area of the holder) is painted and/or covered with a coating because the teeth of the corrugated strip can “bite” particularly well into a layer of paint respectively coating.

According to a further preferred embodiment of the holder according to the invention, at least one first carriage guide element of the two carriage guide elements can be formed as a C-profile. At least one first base body guide element of the two base body guide elements can be formed as a T-profile. The T-profile can correspond to the C-profile, in particular, in such a way that the T-profile is movable respectively displaceable within the C-profile.

Alternatively or additionally, at least one first base body guide element of the two base body guide elements can be formed as a C-profile. At least one first carriage guide element of the two carriage guide elements can be formed as a T-profile. The T-profile can correspond to the C-profile, in particular, in such a way that the T-profile is movable or displaceable within the C-profile.

As already described, in one embodiment, the carriage guide elements can be formed to be essentially identical. The base body guide elements can also be formed to be essentially identical. Preferably, the carriage guide elements can be formed as guide rails with a C-profile and the base body guide elements can be formed as guide rails with a T-profile corresponding to the C-profile, or the carriage guide elements can be formed as guide rails with a T-profile and the base body guide elements as guide rails with a C-profile corresponding to the T-profile. In the case of corresponding profiles of the guide elements, it is possible to reliably enable engaging and relatively moving of the carriage and the base body in relation to each other.

According to a further preferred embodiment of the holder according to the invention, the holder can comprise a release lock respectively locking mechanism. The release lock can be configured at least to prevent an (unintentional) second moving between the base body and the carriage and thus an (unintentional) release of the seizing of the holder with the cylinder element. In particular, vibrations may occur during operation in passenger transport vehicles, but also in other applications. In order to prevent an unintentional release of the seizing respectively the seized state of the holder, even when vibrations occur, it is proposed, according to this embodiment, to provide a release lock for (permanently) locking respectively fixing the holder.

According to a further embodiment of the holder according to the invention, the release lock can be configured to establish a locked seized state respectively fixed seized state of the holder, in particular, after a seizing of the holder has been established by the described relatively moving of the carriage and the base body to one another.

According to a further preferred embodiment of the holder according to the invention, the release lock can comprise at least one screw connection establishable between the carriage and the base body (in the seized state of the holder). In particular, the carriage and the base body can be locked and fixed, respectively, to one another by means of a screw connection. A screw connection can preferably be established in a simple manner by means of a threaded rod respectively screw and a counter piece, such as a nut. If necessary, further elements can be used, such as lock washers, etc.

In particular, a single fitter can initially provide a seizing of the holder with the cylinder element by means of the relatively moving of the carriage and the base body described above. Then, the at least one screw connection can be established by this fitter, since, due to the self-locking effect described above, no hand is needed to hold the holder in the desired position.

Preferably, two screw connections (essentially running parallel) can be provided (each formed by at least one threaded rod and a counter piece, such as a nut).

Alternatively or in addition to a screw connection respectively threaded rod with a counter piece, a release lock can comprise notches, locking bolts and/or seizing or tensioning devices.

According to a particularly preferred embodiment of the holder according to the invention, one end of a threaded rod (respectively screw) of the screw connection can be pivotally attached to the base body respectively to the carriage. Preferably, the at least one threaded rod can be pivotally attached to the base body, for example, by means of a pivot joint. The threaded rod can be pivotable between an open position and a closed position. In the open position, the carriage can be moved relative to the base body with the corresponding base body guide elements and carriage guide elements in engagement with each other in such a way that a seized state of the holder is selectively caused or released. In particular, in the open position, the base body guide elements and the carriage guide elements can be brought into engagement with each other. Then, in the open position, a relative movement of the carriage and the base body can be caused so that the seizing of the holder is caused.

In the closed position (and in particular in the seized state of the holder), the at least one screw connection can be established in such a way that (from the seized state) a locked seized state respectively fixed seized state of the holder can be established.

In particular, to establish a seizing, the at least one threaded rod permanently attached to the base body—preferably two parallel threaded rods respectively screws can be attached—can be pivoted into the open position. After the seizing of the holder has been established in the manner described above, the at least one threaded rod can be set to the closed position by pivoting (in particular, by essentially 180°). In the closed position, the screw connection can be established, in particular, by means of a counter piece (in particular, a nut). For this purpose, the counter piece can be screwed in a known manner onto the free end of the threaded rod.

In particular, the carriage can have a stop section against which the counter piece is pressed by the screw connection. This has the effect, in particular, that the carriage is moved respectively displaced (a little) further relative to the counter piece.

In particular, if at least one of the aforementioned corrugated strips is present, the micro-toothing between the corrugated strip and the cylinder element and thus, in particular, the static friction can be further increased. In a particularly secure manner, a device can be permanently mounted to respectively held on the cylinder element by means of the holder.

As already described, a threaded rod respectively screw can alternatively be arranged pivotally on the carriage. The previous explanations can be transferred to this.

According to a further embodiment of the holder according to the invention, the base body can comprise at least one first auxiliary opening. The first auxiliary opening can be configured to allow a first auxiliary screw connection between the base body and the cylinder element (in the seized state, in particular, the locked seized state). Preferably, the at least one first auxiliary opening (e.g., a round hole) of the base body can be arranged in the base body contact surface. In particular, at least two first auxiliary openings can be arranged. For example, the at least one first auxiliary opening can be positioned between two parallel corrugated strips. In one embodiment, a first auxiliary opening can be arranged in an upper end region of the base body contact surface and a further first auxiliary opening can be arranged in a lower region of the base body contact surface.

In particular, it has been recognized that in extremely few cases it may happen that the described anti-twist protection and the described static friction between the (mounted and braced respectively locked) holder and the cylinder element may not be sufficient for mounting in a secure manner. In this case, the at least one first auxiliary opening can enable an inserting of a screw. For example, a pointed screw can be screwed in through a first auxiliary opening, which can press into the cylinder element and thus in particular fix the position of the holder relative to the cylinder element (sufficiently).

According to a further embodiment of the holder according to the invention, the carriage can comprise at least one second auxiliary opening. The second auxiliary opening can be configured to allow a second auxiliary screw connection between the carriage and the cylinder element. Preferably, the at least one second auxiliary opening (e.g. a round hole) of the carriage can be arranged in the carriage contact surface. For example, the at least one second auxiliary opening can be positioned between two parallel corrugated strips.

In particular, it has been recognized that in extremely few cases, the described anti-twist protection and the described static friction between the (mounted and braced respectively locked) holder and the cylinder element may not be sufficient for a secure mounting. In this case, the at least one second auxiliary opening can enable the inserting of a screw. For example, a pointed screw can be screwed in through a second auxiliary opening, which can press into the cylinder element and thus (sufficiently) fix the position of the holder relative to the cylinder element.

A further aspect of the invention is a use of a previously described holder for mounting a device to a cylinder element in the form of a tube. Preferably, the device can be a previously described validator. Further exemplary devices are, for example, compact payment terminals, in particular, for cashless payment or compact access control devices for reading, in particular, contactless access authorizations (e.g., optical codes, NFC tickets and similar) or for entering access codes using a keyboard or a touch screen.

A further aspect of the invention is a method for mounting a previously described holder to a cylinder element. The method comprises:
placing the base body on the cylinder element in such a way that the base body contact surface makes contact, at least in sections, with an outer side of the cylinder element, or placing the carriage on the cylinder element in such a way that the carriage contact surface makes contact, at least in sections, with the outer side of the cylinder element,
bringing the corresponding base body guide elements and carriage guide elements into engagement with each other, and
subsequently moving the carriage relative to the base body in the longitudinal direction in such a way that a (self-locking) seizing of the holder with the cylinder element is caused.

In particular, the base body can be placed against the cylinder element in such a way that the at least one anti-twist element projects into an opening of the cylinder element, in particular, into the cable opening of the cylinder element.

Preferably, an optional release lock can be provided, which is settable between an open state and a closed state. As already described, for example, at least one threaded rod can be arranged on the holder so as to be pivotable between an open position (i.e., an open state) and a closed position (i.e., a closed state). Before, during or after the base body is placed against the cylinder element, in particular, the release lock can be set to the open state, for example, the at least one threaded rod can be pivoted into the open position.

In particular, an attaching of the carriage can comprise an engagement of the corresponding base body guide elements and carriage guide elements. As already described, first guide rails, for example, with a T-profile (respectively a C-profile), can be provided as base body guide elements and second guide rails, for example, with a C-profile corresponding to the T-profile (respectively with a T-profile corresponding to the C-profile), can be provided as carriage guide elements. In particular, engagement may comprise partially inserting the guide rails having the T-profile into the guide rails having the C-profile. In particular, the carriage may be moved (after engagement) relative to the base body substantially in the longitudinal direction (along the longitudinal axis of the cylinder element).

The moving of the carriage relative to the base body in the longitudinal direction is such that the holder is seized with the cylinder element. In particular, the carriage can be displaced relative to the base body with a cylinder element arranged between the carriage and the base body in such a way that the effective holder diameter, which is formed by the opposing carriage and base body contact surfaces, is continuously reduced, in particular, until the (effective) holder diameter essentially corresponds to the outer cylinder element diameter. In particular, the preferably provided at least two corrugated strips of the holder can then contact respectively (directly) touch the cylinder element. A micro-toothing as described can be established.

After the seized state has been established, a locked seized state respectively fixed seized state can preferably be established by means of the mentioned release lock. In particular, the release lock can be switched from the open state to the closed state. For example, a threaded rod can be pivoted into the closed position. Then, by means of a counter piece, for example, a nut, a screw connection can be established between the carriage and the base body.

A further aspect of the invention is a device set. The device set comprises a previously described holder. The device set comprises a device mountable to a cylinder element by means of the holder. In particular, the device set can be a validator set comprising the previously described holder and, as a device, a validator mountable to a cylinder element by means of the holder.

A yet further aspect of the invention is a passenger transport vehicle. The passenger transport vehicle comprises a cylinder element in the form of a tube. The passenger transport vehicle comprises a holder mounted to the cylinder element and described above. The passenger transport vehicle comprises a device, in particular, a validator (described above) mounted to the holder.

It should be noted that the terms “first”, “second”, etc. do not indicate any order, but merely serve to distinguish two elements (e.g. auxiliary openings, guide rails, etc.) from each other, unless expressly stated otherwise.

The features of the holders, uses, methods, device sets and passenger transport vehicles can be freely combined with each other. In particular, features of the description and/or the dependent claims, also with complete or partial circumvention of features of the independent claims, in a sole position or freely combined with each other, can independently be inventive.

### BRIEF DESCRIPTION OF THE DRAWINGS

There are now a multitude of possibilities for designing and further developing the holder, the use, the method, the device set and the passenger transport vehicle according to the invention. In this regard, reference is made, on the one hand, to the claims subordinate to the independent claims and, on the other hand, to the description of embodiments in conjunction with the drawing. The drawings show:

FIG. 1a a schematic front view of an embodiment of a base body of a holder according to the invention,

FIG. 1b a schematic sectional view of the embodiment according to FIG. 1a,

FIG. 1c a first schematic perspective view of the embodiment according to FIG. 1a,

FIG. 1d a schematic top view of the embodiment according to FIG. 1a,

FIG. 1e a further schematic perspective view of the embodiment according to FIG. 1a,

FIG. 2a a schematic front view of an embodiment of a carriage of a holder according to the invention,

FIG. 2b a schematic sectional view of the embodiment of FIG. 2a,

FIG. 2c a first schematic perspective view of the embodiment of FIG. 2a,

FIG. 2d a further schematic perspective view of the embodiment of FIG. 2a,

FIG. 2e a schematic plan view of the embodiment according to FIG. 2a,

FIG. 3 a diagram of an embodiment of a method according to the invention,

FIG. 4a a schematic perspective view of an embodiment of a holder according to the invention in a first state,

FIG. 4ba a further schematic perspective view of the embodiment according to FIG. 4a in a second state,

FIG. 4bb a schematic plan view of the embodiment according to FIG. 4a in the second state,

FIG. 4ca a further schematic perspective view of the embodiment according to FIG. 4a in a third state,

FIG. 4cb a schematic top view of the embodiment according to FIG. 4a in the third state,

FIG. 4da a further schematic perspective view of the embodiment according to FIG. 4a in a fourth state,

FIG. 4db a schematic top view of the embodiment according to FIG. 4a in the fourth state, and

FIG. 5 a schematic view of an embodiment of a passenger transport vehicle according to the invention with an embodiment of a device set according to the invention.

Similar elements are designated by similar reference signs below.

### DETAILED DESCRIPTION OF SPECIFIC EMBODIMENTS

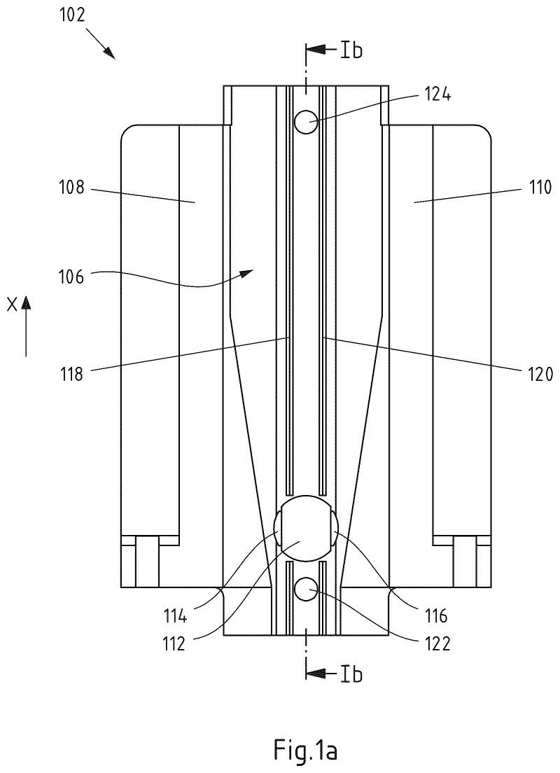

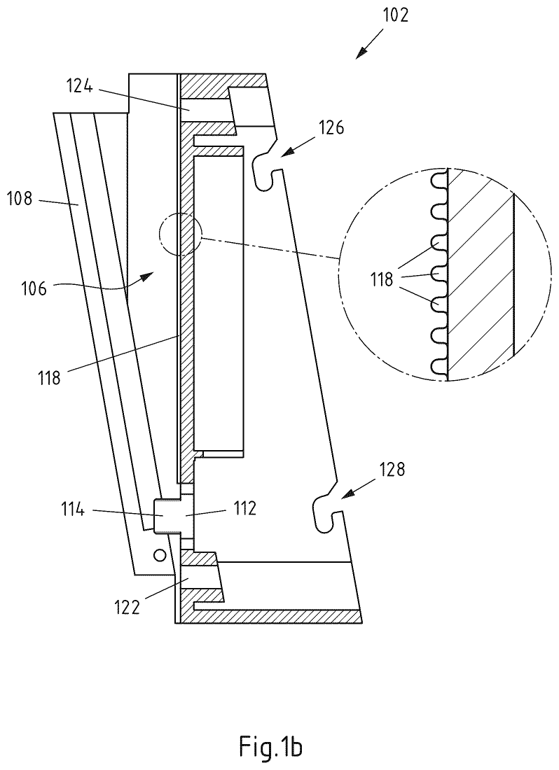

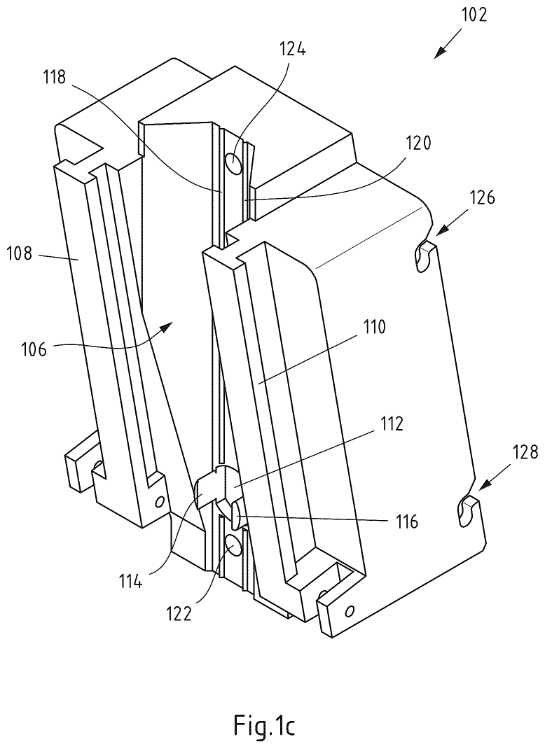

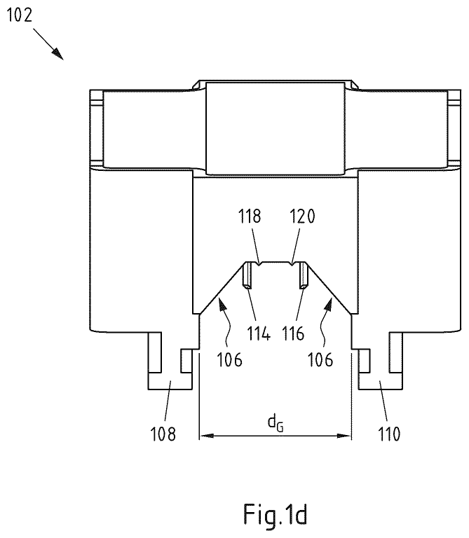

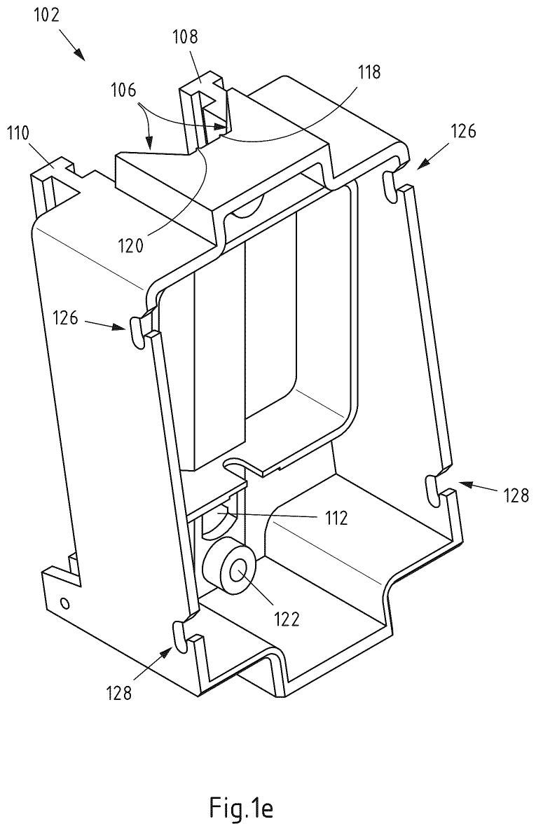

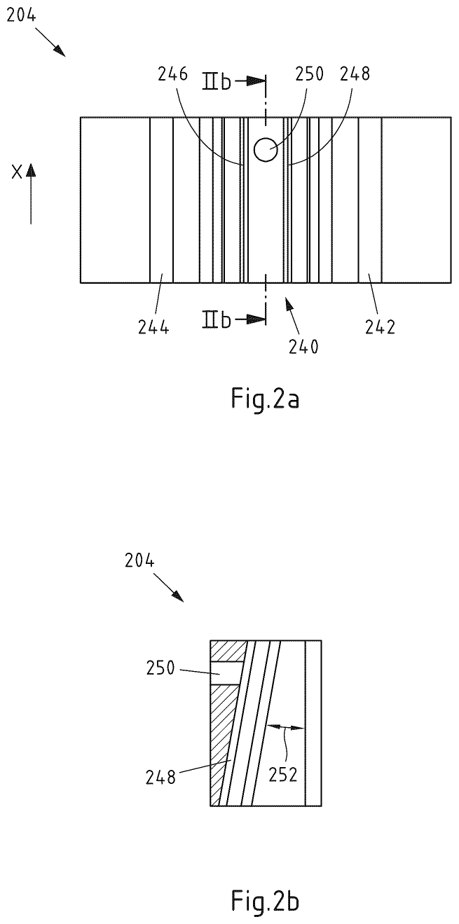

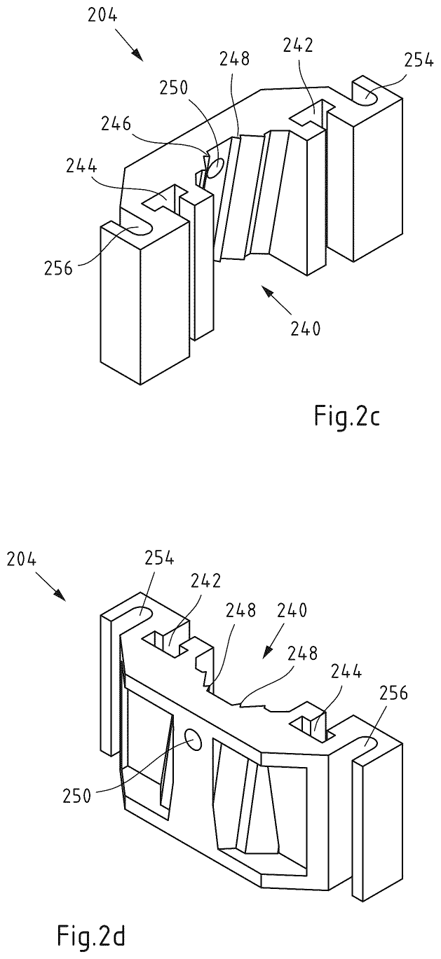

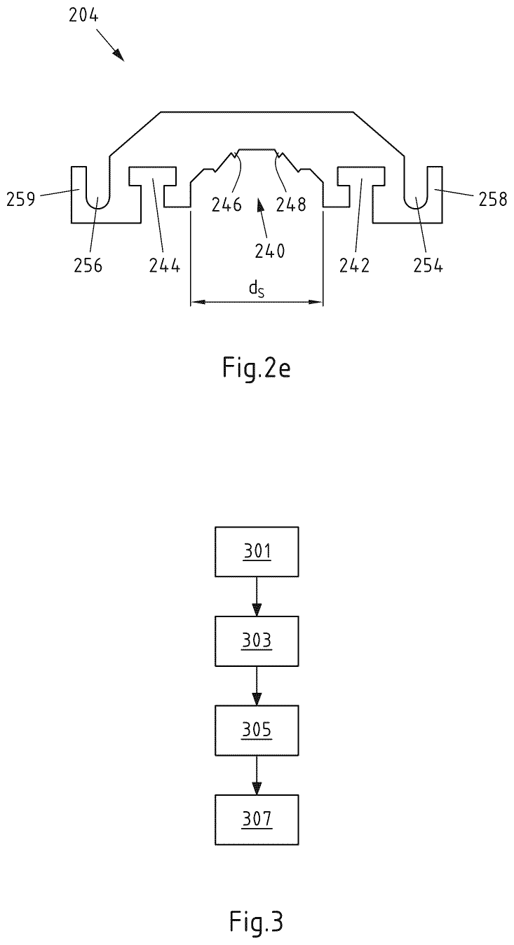

FIGS. 1a to 1e show schematic views of a base body 102 of an embodiment of a holder according to the invention, and FIGS. 2a to 2e show schematic views, in particular, of a carriage 204 of this holder.

In particular, the holder is formed in two parts and can be formed essentially by the base body 102 and the carriage 204 connectable and couplable, respectively, to the base body 102. In particular, the base body 102 can be formed from a metal, for example, aluminum. Preferably, the base body 102 can be a cast part or a milled part.

As can be seen from FIGS. 1a to 1e, the base body 102 comprises a base body contact surface 106 extending in the longitudinal direction x for at least partially contacting with an outer side of a (not shown) cylinder element. The inner shape of the base body contact surface 106 corresponds, in particular, to an outer shape of the cylinder element. This means, for example, that, as can be seen in particular from FIG. 1d, the course of the inner contour can be essentially semicircular, but in the present case is at least partially angular and rectilinear, for example, trapezoidal with an open long base side.

The diameter d_{G} respectively the extent of the open long base side (see in particular FIG. 1d) can be selected depending on the external diameters of the cylinder elements occurring in practice. As already described, the external diameters of the cylinder elements in the (various) passenger transport vehicles can vary, in particular, between 28 mm and 45 mm. In particular, the diameter da can be at least 45 mm, for example, between 45 mm and 50 mm.

In addition, the base body 102 comprises at least two base body guide elements 108, 110 extending in the longitudinal direction x. In particular, the two base body guide elements 108, 110 are formed identically. A base body guide element 108, 110 is, in particular, formed as a (first) guide rail, in the present case exemplarily with a T-profile. A first base body guide element 108 can run on a first side of the base body contact surface 106 and the other base body guide element 110 can run on the other (opposite) side of the base body contact surface 106.

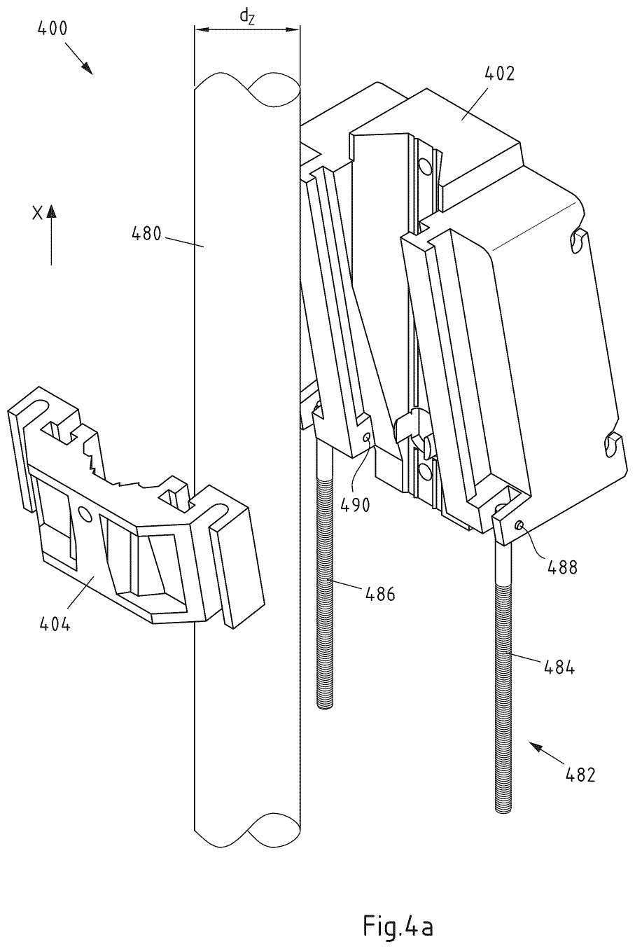

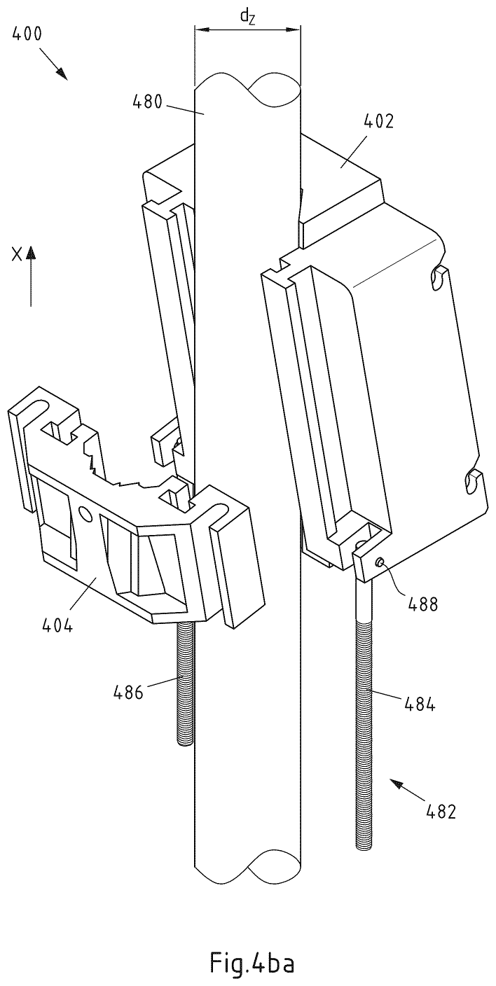

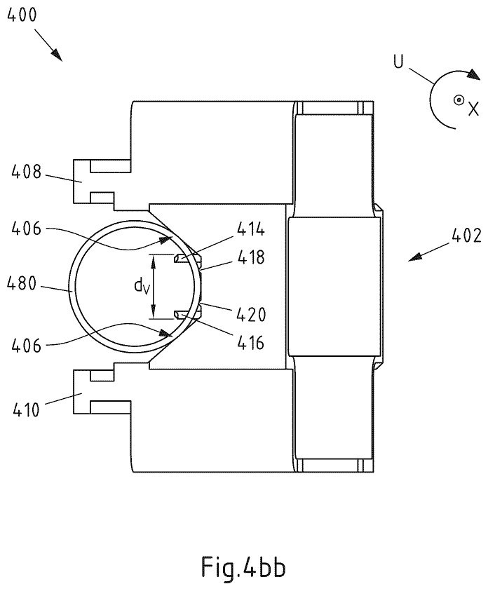

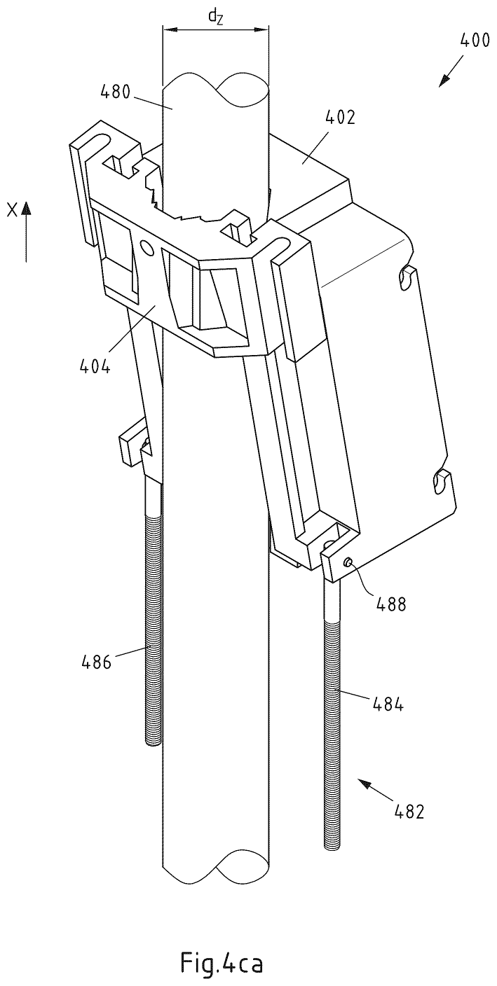

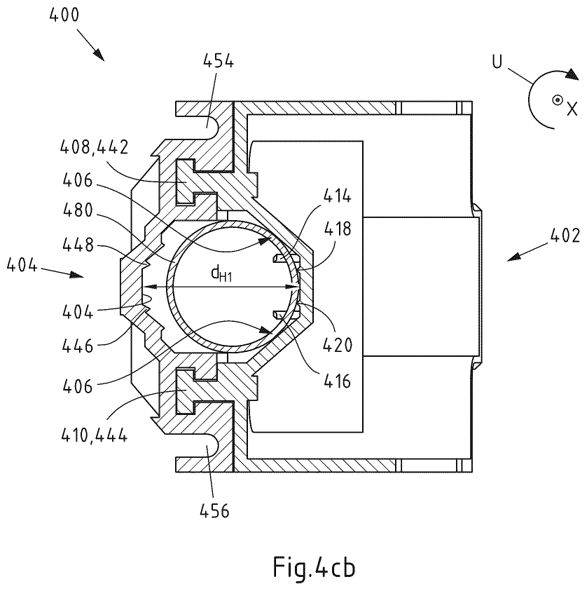

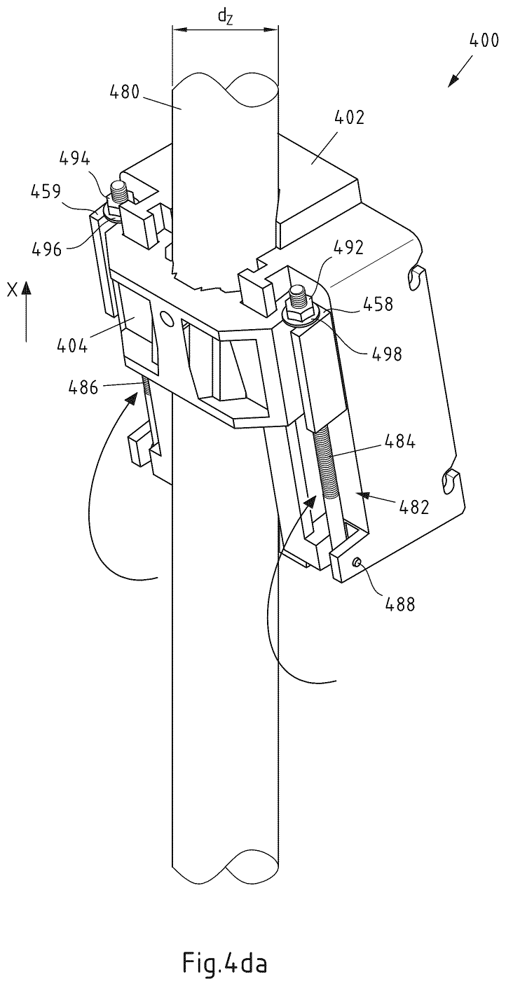

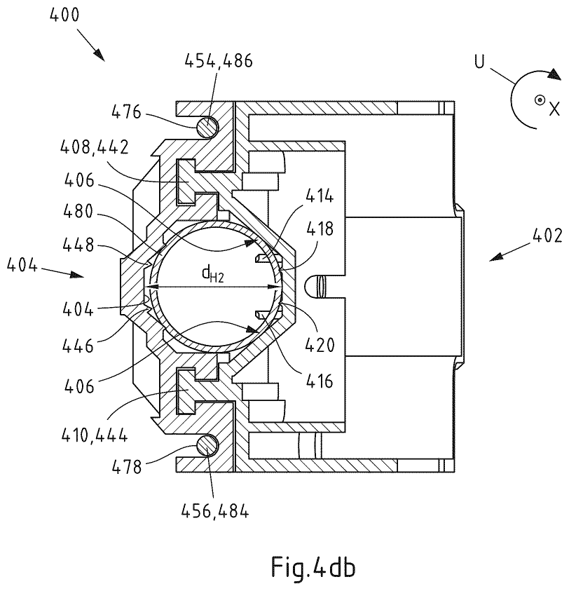

As can be seen, in particular, from FIG. 1b, according to the invention, the base body contact surface 106 and the base body guide elements 108, 110 are tilted relative to one another by a base body angle 130 between 1° and 25°. Preferably, the base body angle can be between 9° and 12°, and particularly preferably essentially 10°. As will be further explained, in particular, with reference to FIGS. 3 through 4db, this titled arrangement can significantly simplify the mounting of the holder.

Optionally and preferably, the base body 102 can comprise a base body cable opening 112, which can be preferably arranged in the base body contact surface 106. The base body cable opening 112 (for example essentially a round hole) can correspond to a cable opening of the cylinder element, in particular, in such a way that, in a seized state, a cable can be guided out of the cylinder element through the cable opening of the cylinder element and directly into the base body cable opening 112. For this purpose, the said openings can be located opposite one another in the seized state. In other words, the base body cable opening 112 is configured, in particular, to pass at least one cable led out of the cable opening of the cylinder element through the holder. It shall be understood that in variants of the invention two or more cables can also be provided.

In addition, the base body 102 can optionally comprise at least one anti-twist element 114, 116 protruding from the base body contact surface 106. Preferably, and as shown (see, for example, FIG. 1d), two anti-twist elements 114, 116 can be provided. An anti-twist element 114, 116 can project from the surface of the inner side of the base body contact surface 106 and, in particular, in a seized state of the holder, can project into an opening of the cylinder element, in particular, into the cable opening of the cylinder element. Preferably, the two anti-twist elements 114, 116 can form a sub-region of the edge region of the base body cable opening 112 and, in particular, lie opposite one another. Preferably, the at least one anti-twist element 114, 116 can be a partially collar-shaped anti-twist element 114, 116. As can be seen, a respective anti-twist element 114, 116 can extend in the longitudinal direction x.

As shown in the preferred embodiment, the base body contact surface 106 can comprise at least one corrugated strip 118, 120 extending in the longitudinal direction for contacting the outer side of the cylinder element 480, 580. Preferably, at least two parallel corrugated strips 118, 120 can be provided. As indicated in the enlargement of FIG. 1b, a corrugated strip 118, 120 can have a plurality of longitudinally alternating ridges and grooves.

In addition, two first auxiliary openings 122, 124 are arranged in the present embodiment. The first auxiliary opening 122, 124 is, in particular, configured to allow an establishing of an auxiliary screw connection between the base body 102 and the cylinder element. For example, a pointed screw (not shown) can be screwed in through the auxiliary opening 122, 124.

In order to mount the device to be held to the holder, the base body 102 can comprise at least one fastening means 126, 128, in particular, a plurality of fastening means 126, 128. It shall be understood that the base body 102 can further comprise (not shown) securing means (or at least parts of securing means) with which a mounted device to be held can be secured against unintentional removal.

As already described, FIGS. 2a to 2e show different views of a carriage 204 that is connectable to the base body 102 according to FIG. 1 and, in particular, together with the base body 102, forms the (two-part) holder.

The carriage 204 can be formed, in particular, from a metal, for example aluminum. Preferably, the carriage 204 can be a cast part or a milled part.

The carriage 204 comprises a carriage contact surface 240 extending in the longitudinal direction x for at least partially contacting the outer side of the (not shown) cylinder element. The inner shape of the carriage contact surface 240 corresponds, in particular, to an outer shape of the cylinder element. This means, for example, that, as can be seen, in particular, from FIG. 2e, the course of the inner contour can be essentially semicircular, in the present case in particular partially angular and rectilinear, for example, trapezoidal with an open long base side.

The diameter d_{S} and/or the extent of the open long base side can be selected depending on the external diameters of the cylinder elements occurring in practice, as already described. In particular, the diameter d_{S} can be at least 45 mm, for example, between 45 mm and 50 mm. In particular, the mentioned diameters d_{S} and d_{G} can be matched to each other and preferably be essentially identical.

In addition, the carriage 204 comprises at least two carriage guide elements 242, 244 extending in the longitudinal direction x. The two carriage guide elements 242, 244 are, in particular, identical. One carriage guide element 242, 244 is, in particular, formed as a (second) guide rail, in the present case exemplarily with a C-profile. A first carriage guide element 242 can extend on a first side of the carriage contact surface 240 and the other carriage guide element 244 can extend on the other (opposite) side of the carriage contact surface 240.

As can be seen in particular from FIG. 2b, according to the invention, the carriage contact surface 240 and the carriage guide elements 242, 244 are tilted relative to one another by a carriage angle 252 between 1° and 25°. Preferably, the carriage angle 252 can be between 9° and 12°, particularly preferably substantially 10°. As will be explained in more detail, in particular, with reference to FIGS. 3 to 4db, the mounting of the holder can be significantly simplified by this tilted arrangement.

In particular, the base body angle 130 and the carriage angle 252 can be essentially the same, preferably both between 9° and 12°, in particular, essentially 10°.

As shown in the preferred embodiment, the carriage contact surface 240 can comprise at least one corrugated strip 246, 248 extending in the longitudinal direction for contacting the outer side of the cylinder element 480, 580. Preferably, at least two parallel corrugated strips 246, 248 can be provided. A corrugated strip 246, 248 can be formed according to the above-described corrugated strips (see also the enlarged view of FIG. 1b).

In addition, the carriage 204 in the present embodiment optionally comprises a second auxiliary opening 250. The second auxiliary opening 250 (e.g., a round hole) can be arranged, in particular, in the carriage contact surface 240. The second auxiliary opening 250 is, in particular, configured to allow an establishing of an auxiliary screw connection between the carriage 204 and the cylinder element. For example, a pointed screw (not shown) can be screwed in through the second auxiliary opening 250.

Optionally and preferably, two grooves 254, 256 running in the longitudinal direction x can be arranged. In particular, the grooves 254, 256 can be arranged essentially parallel to the carriage guide elements 242, 244. As will be described in more detail, the grooves 254, 256 can be configured to accommodate respective threaded rods and screws, respectively, to lock the holder. The end of a respective groove 254, 256 can serve as a stop section 258, 259, against which a counter piece (not shown) of a screw connection can be stopped.

The base body guide elements 108, 110 can correspond to the carriage guide elements 242, 244 in such a way that, when the carriage 204 moves relative to the base body 102 with the corresponding base body guide elements 108, 110 and carriage guide elements 242, 244 in engagement with each other, the holder is seized with the cylinder element.

FIG. 3 shows a diagram of a method for mounting a holder to a cylinder element. The method is described in more detail with the help of FIGS. 4a to 4db, which show a preferred embodiment of a holder 400 according to the present invention in different states, in particular, different assembly states. In order to avoid repetitions, only the differences between the holder 400 and the embodiments according to FIGS. 1 and 2 will be described below, otherwise reference is made to the previous explanations.

FIG. 4a shows the holder 400, in particular, in a first state in which neither the base body 402 nor the carriage 404 is in contact with the cylinder element 480. The cylinder element 480 may preferably be a (hollow cylindrical) tube. For example, the tube may be arranged in a (not shown) passenger transport vehicle or the like. In a state installed in the passenger transport vehicle, the cylinder element 480 can extend in a vertical direction x. Furthermore, a diameter d_{Z} of the cylinder element 480 can vary between 28 mm and 45 mm. In particular, cylinder elements with different diameters can be arranged in different passenger transport vehicles.

At least one cable (not shown) can be routed through the interior of the cylinder element 480, such as a data cable and/or power cable. The cable can be used for supplying power to at least one electrical consumer of the (not shown) device, which can be mounted by the holder, and/or for exchanging data between the device and a computing device, such as a computing device of a passenger transport vehicle and/or a background system (e.g., formed by at least one server, a cloud, etc.) of a passenger transport system (in particular, comprising at least the passenger transport vehicle).

In a step 301, the base body 402 is placed against the cylinder element 480 in such a way that the base body contact surface 406 contacts an outer side of the cylinder element 480, at least in sections, as shown in FIGS. 4ba and 4bb (alternatively, the carriage can be placed on the cylinder element in such a way that the carriage contact surface contacts the outer side of the cylinder element at least in sections). In particular, the holder is in a first pre-assembly state in which the base body is already (loosely) arranged on the cylinder element. In particular, the corrugated strips 418, 420 contact the outer side of the cylinder element 480 in this first pre-assembly state.

As can be seen from FIGS. 4a to 4db, the holder 400 preferably comprises a release lock 482. The release lock 482 is, in particular, configured to at least prevent an unintentional second movement between the base body (102, 402) and the carriage (204, 404) and thus a release of the seizing of the holder 400 with the cylinder element 480 respectively the seized state of the holder 400. As will be described in more detail, the release lock 482 can be configured to establish a (permanent, but in particular releasable) locking respectively fixing of the holder 400 to the cylinder element 480.

Preferably, the release lock 482 can comprise at least one screw connection, preferably two screw connections, establishable between the carriage 404 and the base body 402. Preferably, the release lock 482 can comprise two threaded rods 484, 486 and screws, respectively, and a corresponding number of counter pieces 492, 494, in particular, in the form of nuts. Optionally, at least one respective washer 496, 498 can be present.

Preferably, one end of a respective threaded rod 484, 486 of the screw connection can be pivotally attached (e.g., by means of a pivot joint 488, 490) to the base body 402. In variants of the invention, an attachment to the carriage is also possible.

The respective threaded rod 484, 486 can be pivotable between an open position and a closed position. In particular, in step 301, the release lock 482 can be set to an open state. In the present embodiment, this means, in particular, that the respective threaded rod 484, 486 is moved into the open position (e.g., by a fitter), as shown in FIGS. 4ba and 4bb.

The placing of the base body 402 zo the cylinder element 480 may, in particular, comprise an inserting of the anti-twist elements 414, 416 into an opening of the cylinder element, in particular, into the cable opening of the cylinder element 480. The outer diameter dv (see FIG. 4bb) of the at least two opposing anti-twist elements 414, 416 can essentially correspond to the (not shown) inner diameter of an opening of the cylinder element, in particular, the cable opening of the cylinder element 480 (e.g., with a predetermined tolerance). This can prevent the holder (and thus the device mounted to it) from twisting when the holder 400 is in a seized state. In addition, the base body 402 and thus the holder 400 can be arranged in the exact (respectively desired) position on the cylinder element 480. In this position, the at least one cable can then be routed out of the cylinder element 480 through the cable opening and into the base body cable opening 412 (in particular, to the device).

In a step 303, the corresponding base body guide elements 408, 410 and carriage guide elements 442, 444 are engaged with one another (e.g. by a fitter), as shown in FIGS. 4ca and 4cb.

In this way, a guide rail with a T-profile engages in a corresponding guide rail with a C-profile, as can be seen, in particular, in FIG. 4cb. In this second pre-assembly state of the holder 400, the carriage 404 can be moved respectively slid relative to the base body 402, in particular, in the longitudinal direction x (which is essentially identical to the longitudinal axis direction of the cylinder element 480).

As can be seen in FIGS. 4ca and 4cb, the release lock 482 is also in the open state in the second pre-assembly state. In other words, the threaded rods 484, 486 are in the open position in the present embodiment. In particular, the carriage 404 can be moved in the open position relative to the base body 402 when the corresponding base body guide elements 408, 410 and carriage guide elements 442, 444 are in engagement with each other in such a way that a seized state of the holder 400 can be caused.

In step 305, the carriage 404 is moved relative to the base body 402 in the longitudinal direction x in such a way that, in particular, a self-locking seizing of the holder 400 with the cylinder element 480 is caused.

In particular, the carriage 404 can be displaced relative to the base body 402 in such a way that, in particular, an effective holding diameter d_{H1}, which results from the distance between the opposing carriage contact surface 440 and base body contact surface 406, is continuously reduced (see FIGS. 4cb and 4db), in particular, until the effective holder diameter d_{H2} essentially corresponds to the outer cylinder element diameter. In this state, also referred to as the seized state (not shown), the holder 400 is held seized to the cylinder element due to the static friction acting in the contacting areas. In particular, the corrugated strips 418, 420, 446, 448 contact the outer side of the cylinder element 480 in this state. In particular, a self-locking effect of the base body 402, carriage 404 and cylinder element 480, which does not release independently as long as the position of the carriage 404 is, in particular, not changed by vibration or other mechanical (manual) influence. This means that a single fitter can initially establish the seized state, then can let go the pre-assembled holder and lock and fix, respectively, it with the release lock 482.

Preferably, in step 307, after a seized state has been established, a locked seized state respectively fixed seized state can be established by means of the release lock 482. In particular, the release lock 482 can be set from the open state to the closed state. In particular, the two threaded rods 484, 486 can be pivoted into the closed position (e.g., by the fitter). In the closed position, a respective threaded rod center piece 476, 478 (see FIG. 4d) can extend through the respective groove 454, 456. The respective open end can project out of the respective groove 454, 456. In order to establish a screw connection, a counter piece 492, 494 in the form of a nut can be screwed onto the respective end and, in particular, can stop against the respective stop section 458, 459. A secure fixing respectively locking of the holder 400 can be achieved.

As already described, optionally at least one auxiliary screw connection can be established. In particular, a screw (not shown) can be screwed through a first auxiliary opening 422, 424 and/or through a second auxiliary opening 450 to fix the holder 400 (even more strongly) to the cylinder element 480.

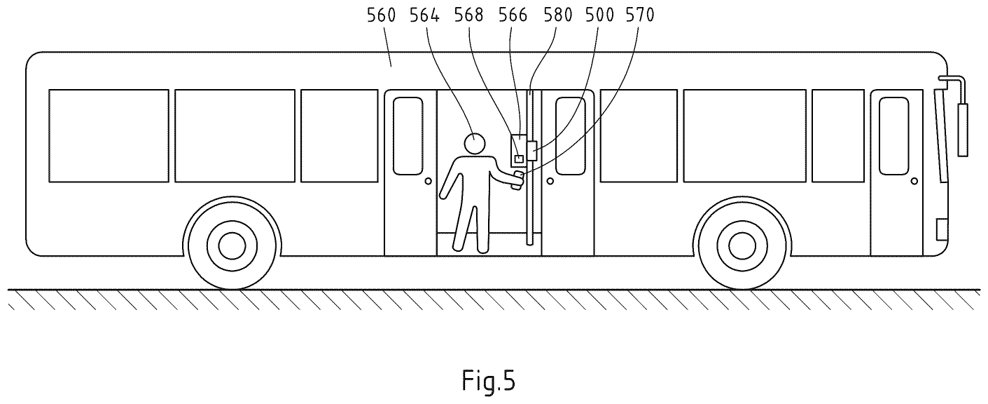

FIG. 5 shows a schematic view of an embodiment of a passenger transport vehicle 560 according to the invention with an embodiment of a device set 562 according to the invention. In order to avoid repetitions, only the differences to the previous embodiments will be described below, otherwise reference is made to the previous explanations. Furthermore, it should be noted that the details of the holder 500 are not shown in favor of a better overview. In particular, the holder 500 can be formed according to a previously described holder (see, for example, FIG. 1 to 4db).

The passenger transport vehicle 560 is configured to transport users 564 and passengers, respectively. In the present case, the passenger transport vehicle 560 is exemplified by a bus. It shall be understood that other passenger transport vehicles may be provided in variants of the invention, such as rail vehicles or watercrafts.

As can be seen, the passenger transport vehicle 560 comprises at least one cylinder element 580, in particular, in the form of a tube respectively a holding bar in a boarding area and/or exit area of the passenger transport vehicle 560. In particular, a plurality of cylinder elements can be arranged in a passenger transport vehicle 560.

The device set 562 comprises the holder 500 and a device 566 mountable to the cylinder element 580 by means of the holder 500. The holder 500 is mounted to the cylinder element 580, in particular, fixed respectively locked in place, as already described. The device 566 is in turn mounted to the holder 500. In other words, the device 566 is shown in the mounted state.

The device 566 can be a validator 566 and can comprise at least one electronic interface 568 respectively a detecting module with at least one electronic interface 568. The (contactless or contact-based) interface 568 corresponds to the (contactless or contact-based) interface of the ticket medium 570 (e.g., a smartphone).

In order to validate a ticket medium 570, a reading process can be carried out at the validator 566. A detecting process respectively reading process can also be referred to as a “tap”. In particular, a user 564 can hold respectively tap the ticket medium 570 on or in the interface 568 of the validator 566 to cause a detecting of the ticket code and/or the identifier. As already described, the tapping can be contactless, preferably by NFC (e.g. smart cards according to ISO 14443), by reading an optical code (e.g. barcode, QR code) that contains the electronic medium identifier, from a ticket medium 570, by reading data from a Bluetooth interface or in a contact-based manner by reading data from a magnetic stripe or from a contact-based chip from a bank card or credit card. In particular, a ticket medium 570 can be validated by a corresponding reading so that it is considered to be a valid ticket medium 570.

### LIST OF REFERENCE SIGNS

102 base body
106 base body contact surface
108 base body guide element
110 base body guide element
112 base body cable opening
114 anti-twist element
118 corrugated strip
120 corrugated strip
122 first auxiliary opening
124 further first auxiliary opening
126 fastening means
128 fastening means
130 base body angle
204 carriage
240 carriage contact surface
242 carriage guide element
244 carriage guide element
246 corrugated strip
248 corrugated strip
250 second auxiliary opening
252 carriage holder
254 groove
256 groove
258 stop section
259 stop section
301 step
303 step
305 step
307 step
400 holder
402 base body
404 carriage
406 base body contact surface
408 base body guide element
410 base body guide element
412 base body cable opening
414 anti-twist element
416 anti-twist element
418 corrugated strip
420 corrugated strip
422 first auxiliary opening
424 further first auxiliary opening
440 carriage contact surface
442 carriage guide element
444 carriage guide element
446 corrugated strip
448 corrugated strip
450 second auxiliary opening
454 groove
456 groove
458 stop section
459 stop section
476 threaded rod center piece
478 threaded rod center piece
480 cylinder element
482 release lock
484 threaded rod
486 threaded rod
488 pivot joint
490 pivot joint
492 counter piece
494 counter piece
496 washer
498 washer
500 holder
560 passenger transport vehicle
562 device set
564 user
566 device and validator, respectively
568 interface
570 ticket medium
580 cylinder element

What is claimed is:

1. A holder for mounting to a cylinder element, comprising:
a base body and
a carriage connectable to the base body,
wherein a longitudinal direction of the base body and of the carriage extends essentially parallel to the longitudinal axis of the cylinder element in the mounted state of the holder,
wherein the base body comprises a longitudinally extending base body contact surface for contacting, at least in sections, an outer side of the cylinder element,
wherein the base body comprises at least two base body guide elements extending essentially in the longitudinal direction,
wherein the base body contact surface and the base body guide elements are tilted relative to one another by a base body angle between 1° and 25°,
wherein the carriage comprises a longitudinally extending carriage contact surface for contacting, at least in sections, an outer side of the cylinder element,
wherein the carriage comprises at least two carriage guide elements extending essentially in the longitudinal direction,
wherein the carriage contact surface and the carriage guide elements are tilted relative to one another by a carriage angle of between 1° and 25°,
wherein the base body guide elements correspond to the carriage guide elements in such a way that by a first moving of the carriage relative to the base body,
when the corresponding base body guide elements and carriage guide elements are in engagement with one another, a reducing in a holder diameter (d_{H1}, d_{H2}) is caused so that the holder is seized with the cylinder element arranged between the base body and the carriage.

2. The holder according to claim 1, wherein
a second moving of the carriage relative to the base body, opposed to the first moving, with the corresponding base body guide elements and carriage guide elements engaged with one another, causes an increasing of the holder diameter so that the seizing of the holder with the cylinder element arranged between the base body and the carriage is released.

3. The holder according to claim 1, wherein
the base body angle and the carriage angle are essentially the same.

4. The holder according to claim 1, wherein
the base body angle is between 9° and 12°,
and/or
the carriage angle is between 9° and 12°.

5. The holder according to claim 1, wherein
the base body contact surface is substantially parallel to the carriage contact surface when the base body guide elements and the carriage guide elements are engaged with each other.

6. The holder according to claim 1, wherein
the base body comprises a base body cable opening corresponding to a cable opening of the cylinder element,
wherein the base body cable opening is configured to pass at least one cable led out of the cable opening of the cylinder element through the holder.

7. The holder according to claim 1, wherein
the base body comprises at least one anti-twist element protruding from the base body contact surface,
wherein the anti-twist element projects into an opening of the cylinder element in a seized state of the holder.

8. The holder according to claim 1, wherein
an inner shape of the carriage contact surface essentially corresponds to an outer shape of the cylinder element,
and/or
an inner shape of the base body contact surface essentially corresponds to an outer shape of the cylinder element.

9. The holder according to claim 1, wherein
the carriage contact surface comprises at least one corrugated ridge extending in the longitudinal direction for contacting the outer side of the cylinder element,
and/or
the base body contact surface comprises at least one corrugated strip extending in the longitudinal direction for contacting the outer side of the cylinder element.

10. The holder according to claim 1, wherein
at least one first carriage guide element of the two carriage guide elements is formed as a C-profile, and
at least one first base body guide element of the two base body guide elements is formed as a T-profile which corresponds to the C-profile,
and/or
at least one first base body guide element of the two base body guide elements is formed as a C-profile, and
at least one first carriage guide element of the two carriage guide elements is formed as a T-profile which corresponds to the C-profile.

11. The holder according to claim 1, further comprising
a release lock configured to at least prevent a release of the seizing of the holder with the cylinder element.

12. The holder according to claim 11, wherein
the release lock comprises at least one screw connection establishable between the carriage and the base body.

13. The holder according to claim 12, wherein
one end of a threaded rod of the screw connection is pivotally attached to the base body or to the carriage,
wherein the threaded rod is pivotable between an open position and a closed position,
wherein in the open position the carriage is movable relative to the base body with corresponding base body guide elements and carriage guide elements in engagement with one another such that a seized state of the holder is caused,
wherein in the closed position the screw connection is establishable in such a way that a locked seized state of the holder is establishable.

14. The holder according to claim 1, wherein
the base body comprises at least one first auxiliary opening configured to enable a first auxiliary screw connection between the base body and the cylinder element,
and/or
the carriage comprises at least one second auxiliary opening configured to enable a second auxiliary screw connection between the carriage and the cylinder element.

15. An apparatus comprising:
the holder of claim 1; and
a cylinder element in the form of a tube arranged in a passenger transport vehicle, wherein the holder is arranged for mounting a device to the cylinder element.

16. A method of mounting a holder according to claim 1, comprising:
placing the base body to a cylinder element in such a way that the base body contact surface contacts an outer side of the cylinder element at least in sections, or placing the carriage to the cylinder element in such a way that the carriage contact surface contacts the outer side of the cylinder element at least in section;
bringing the corresponding base body guide elements and carriage guide elements in engagement with one another, and
subsequently moving the carriage relative to the base body in the longitudinal direction in such a way that the holder is seized with the cylinder element.

17. A device set, comprising:
a holder according to claim 1; and
a device mountable to a cylinder element by means of the holder.

18. A passenger transportation vehicle comprising
a cylinder element in the form of a tube;
a holder according to claim 1 and mounted to the cylinder element; and
a device mounted to the holder.

19. The passenger transportation vehicle according to claim 18, wherein
the device is a validator.
